(19) United States
(12) Patent Application Publication
(10) Pub. No.: US 2013/0104700 A1
(43) Pub. Date: May 2, 2013

(54) ENHANCED STAGED ELUTION OF LOADED RESIN

(71) Applicant: Dow Global Technologies LLC, Midland, MI (US)

(72) Inventors: Daryl J. Gisch, Midland, MI (US); Charles R. Marston, Midland, MI (US)

(73) Assignee: DOW GLOBAL TECHNOLOGIES LLC, Midland, MI (US)

(21) Appl. No.: 13/662,945

(22) Filed: Oct. 29, 2012

Related U.S. Application Data
(60) Provisional application No. 61/553,675, filed on Oct. 31, 2011.

(51) Int. Cl. C22B 3/04; C22B 3/02

(52) U.S. Cl. 75/743; 266/168

(57) ABSTRACT

A method and system for recovering metal ions from liquid or slurry solutions through an elution column and an enhancing column, each containing a resin. Eluate is recovered as discrete fractions such that the metal ions are substantially separated from one another.

This invention relates to recovery of metals from solutions and in particular to substantial separation of eluting metals from solutions.

A number of processing techniques result in the formation of metal-containing solutions and pulps or slurries. Ion exchange processes, including resin-in-pulp and resin-in-solution processes, have been used to recover metals from these solutions and slurries.

Many of these processes involve a staged elution. In a typical staged elution (e.g., gradient elution, chromatographic elution) process, an ion exchange resin is loaded with metal ions by passing a solution bearing a plurality of metals ions through a column of the ion exchange resin. The most tightly bound species bind in higher concentrations toward the inlet side of the resin bed and more loosely bound ions are dispersed farther down the resin bed. The resin loaded in this manner is eluted with a series of sequential eluents of various compositions in a fashion to maximize the chromatographic separation of the loaded metals. The metals are eluted from the column, usually in the order of the least “strongly bound” to the “most strongly bound.” The sequentially stratified metal species in the original loaded resin enhances the effectiveness of co-current staged elution. One example of a staged elution is shown in U.S. Pat. No. 6,093,376.

In contrast, batch processes, where the resin is allowed to be contacted with the bulk metal solution, load a plurality of metal species substantially uniform throughout the mass of the resin. When placed in a column for staged elution, the resulting breakthrough separation is generally poor because the loaded resin that is near the column outlet is of the same composition, and the resin throughout the column and the more strongly held metals tend to bleed from the column into the eluate along with the lesser held metals species. Staged elutions often involve the use of expensive resins and result in at least part of the separate metals being contaminated with other metals. Therefore, it is desirable to provide an elution process that uses less expensive resins and is more selective in separating metals.

The invention seeks to enable substantial separation of eluting metals from slurries and solutions. In a first aspect of the invention, there is provided a method for recovering metal ions from liquid or slurry solutions comprising providing an elution column and an enhancing column having a fresh resin; contacting a solution with a resin that removes a plurality of metals from the solution to prepare a loaded resin; transferring the loaded resin to the elution column; adding an eluent to the elution column to pass over and through the loaded resin; liberating the plurality of metals from the loaded resin; passing eluate from the elution column with the plurality of metals through the enhancing column; and recovering the eluate as discrete fractions such that the plurality of metals are substantially separated from one another.

In a second aspect of the invention, there is provided a system for recovering metal ions from liquid and slurry solutions comprising at least one vessel that receives a solution and a resin to be loaded with a plurality of metals; an elution column that receives the loaded resin and an eluent; and an enhancing column having a fresh resin placed in series with the elution column

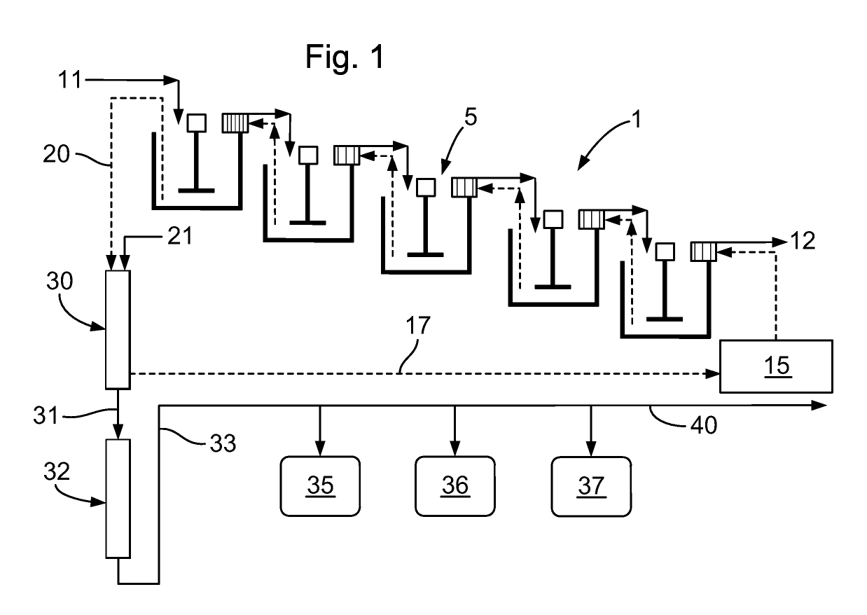

FIG. 1 shows a diagram of the system of the invention;

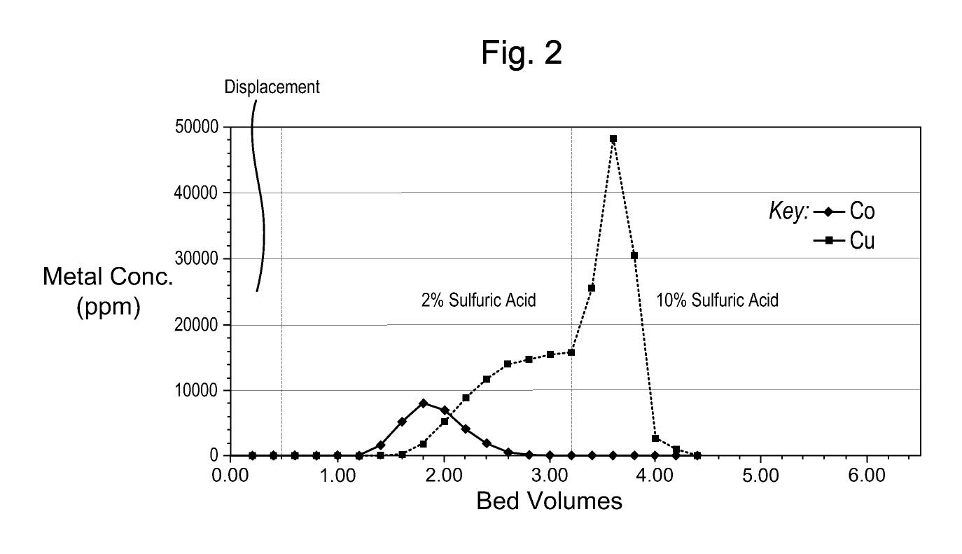

FIG. 2 shows a graph of the results of metal concentration versus bed volumes for copper and cobalt in Comparative Example;

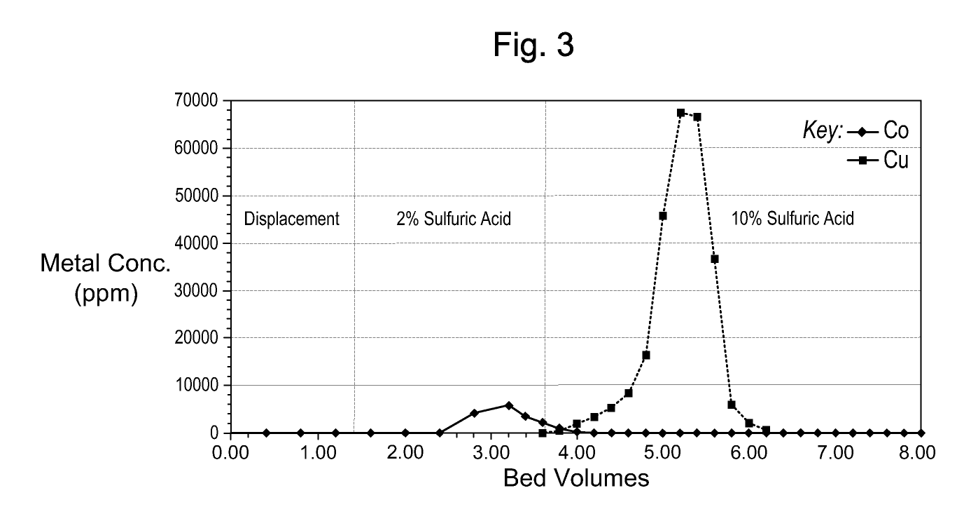

FIG. 3 shows a graph of the results of metal concentration versus bed volumes for copper and cobalt in Example 1; and

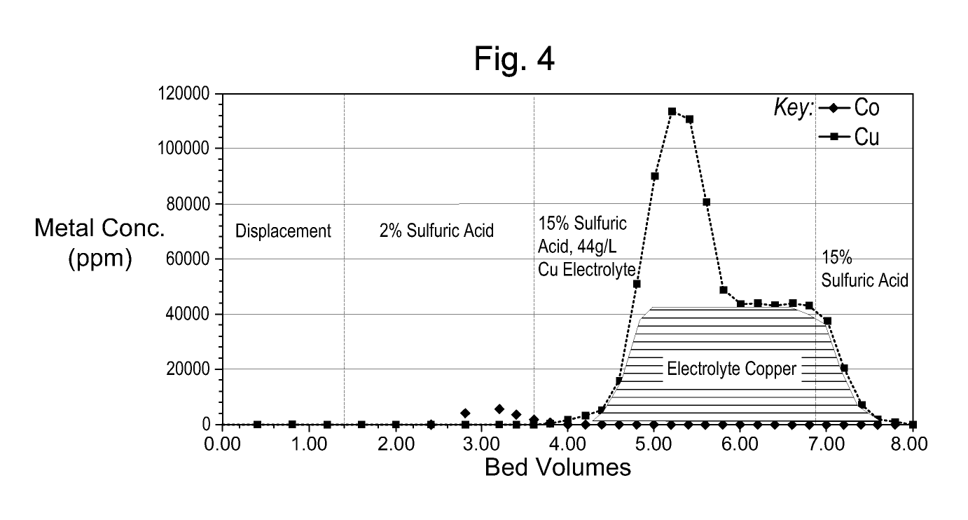

FIG. 4 shows a graph of the results of metal concentration versus bed volumes for copper and cobalt in Example 2.

The invention is directed to an enhanced elution process and system for recovering metals from liquids, slurries, and pulps, which are hereinafter sometimes all referred to as solutions. At least two columns with resin are used to collect the metals and then to separate the metals. In a preferred embodiment, the columns are placed in series. The resin in one column may be the same or different than the resin in the other column The resins used may be chosen based on their selectivity and/or affinity. The resins may bare their metal ions in a randomly dispersed fashion or in a co-current fashion, where the most tightly bound species bind in higher concentrations toward the inlet side of the resin bed and more loosely bound ions are dispersed farther down the resin bed. In a preferred embodiment, co-current operation provides a split elution of less tightly bound metal ions and the more tightly bound metals through the employment of successively more aggressive eluents.

Resins that may be used include ion exchange resins, chelating resins, and adsorbent resins. Ion exchange resins include weak and strong acid cation exchange resins and weak and strong anion exchange resins of either a gel or macroporous type. Cation exchange resins and anion exchange resins are well known in the art. Exemplary resins include Amberlite™ IRC 747, Ambersep™ 400 SO4, Ambersep 4400 HCO3, Ambersep 748 UPS, Ambersep 920 UXL C1, Ambersep 920U C1, Ambersep 920UHCSO4, Ambersep GT74, DOWEX™ 21K 16-20, DOWEX 21K XLT, DOWEX Mac-3, DOWEX RPU, XUS-43578, XUS-43600, XUS-43604, XUS-43605, and XZ-91419, all available from The Dow Chemical Company, Midland, Mich. These resins are exemplary and any other resin may be used in the invention.

In one embodiment, at least one resin is a chelating resin having chelating groups. Exemplary chelating groups include phosphonic acids, sulfonic acids, dithiocarbamates, polyethyleneimines, polyamines, hydroxy amines, carboxylic acids, aminocarboxylic acids and aminoalkylphosphonates. Preferred aminocarboxylic substituents include, for example, substituents derived from nitrilotriacetic acid, ethylenediamine tetraacetic acid (EDTA), diethylenetriamine pentaacetic acid, tris(carboxymethyl)amine, iminodiacetic acid, N-(carbamoylmethyl)iminodiacetic acid, N,N-bis(carboxymethyl)-B-alanine and N-(phosphonomethyl)iminodiacetic acid. Preferably, the fresh resin is a chelating resin. In preparing anion exchange and chelating resins from poly(vinylaromatic) copolymer beads, such as crosslinked polystyrene beads, the beads are first haloalkylated, preferably chloromethylated, and the anion or chelating groups are subsequently substituted onto the haloalkylated copolymer.

Anion exchange or chelating resins may be prepared from the haloalkylated beads by contact with an amine compound capable of replacing the halogen of the haloalkyl group with an amine-based functional group.

Weak-base anion exchange resins may be prepared by contacting the haloalkylated copolymer beads with ammonia, a primary amine, a secondary amine, or polyamines like ethylene diamine or propylene diamine. Commonly employed primary and secondary amines include methylamine, ethylamine, butylamine, cyclohexylamine, dimethylamine, and diethylamine.

Strong-base anion exchange resins may be prepared by contact with tertiary amines, such as trimethylamine, triethylamine, dimethylisopropanolamine, or ethylmethyl propylamine.

Chelating resins may be prepared, for example, by contacting the haloalkylated copolymer beads with an aminopyridine compound, such as a 2-picolylamine. Chelating resins may also be prepared by contacting the haloalkylated copolymer beads with a primary amine to initially convert the copolymer beads to a weak-base anion-exchange resin, followed by contact with a carboxyl-containing compound.

Cation exchange resins may be prepared from the copolymer beads using well known methods. In general, strong acid resins are prepared by reacting the copolymer with a sulfonating agent such as sulfuric acid, chlorosulfonic acid, or sulfur trioxide. Contact with the sulfonating agent can be conducted neat, or with a swelling agent.

An adsorbent resin may be prepared from a copolymer by post-crosslinking individual polymer chains after polymerization. Post-crosslinking may be achieved by swelling the copolymer with a swelling agent and subsequently reacting the copolymer with a polyfunctional alkylating or acylating agent.

To obtain an adsorbent, the porous copolymer beads may be post-crosslinked in a swollen state in the presence of a Friedel-Crafts catalyst to introduce rigid microporosity (pores with a diameter of about 50 Angstroms or less) into the copolymer. In this type of process, the copolymer may be prepared from a monomer mixture comprising a monovinylidene aromatic monomer, as the post-crosslinking step requires the presence of aromatic rings on individual polymer chains. Small amounts of non-aromatic monovinylidene monomers, preferably less than about 30 weight percent based on monomer weight, can be employed in the monomer mixture being polymerized, but it is less desirable to do so as the resulting adsorbents may have decreased amounts of surface area and microporosity. Post-crosslinking of the copolymer while it is in a swollen state displaces and rearranges adjacent polymer chains, thereby causing an increase in the number of micropores. This rearrangement serves to increase overall porosity and surface area of the copolymer, while also decreasing the average pore size. Post-crosslinking also serves to impart rigidity to the copolymer structure, which is important for providing enhanced physical and dimensional stability to the copolymer.

A preferred method for post-crosslinking the copolymer comprises haloalkylating the copolymer with a haloalkylating agent, swelling the resulting haloalkylated copolymer with an inert swelling agent, and thereafter maintaining the swollen, haloalkylated copolymer at a temperature and in the presence of a Friedel-Crafts catalyst such that haloalkyl moieties on the copolymer react with an aromatic ring of an adjacent copolymer chain to form a bridging moiety. It is also preferred to substantially remove excess haloalkylating agent and/or solvents employed in haloalkylating the copolymer prior to post-crosslinking

In terms of porosity, the adsorbent preferably has from about 0.5 to about 1.5 cubic centimeters of pore volume per gram of adsorbent material (cc/g). More preferably, the adsorbent has from about 0.7 to about 1.3 cc/g of porosity.

If desired, the porous copolymer beads may be converted to ion exchange resins by functionalizing them with ion exchange or chelating groups. Techniques for converting copolymers to anion, cation, and chelating resins are known.

The first column is an elution column. The elution column is loaded with a loaded resin that has metals. The loaded resin may be prepared through a variety of processes ranging from single stage to multiple stage processes where resin is contacted with a slurry of ore. The process may be continuous or static. In one example, a series of stirred tanks, resin-in-pulp contactors, or other vessels, are used to mix a feed slurry and an ore slurry. Preferably, the metals are loaded uniformly onto the resin.

The loaded resin may be loaded with any metals. For example, the loaded resin may have at least one metal found in the Periodic Table of Elements. Preferred metals include, but are not limited to, copper, nickel, cobalt, Rare Earth Elements, lithium, uranium, thorium, scandium, iron, zinc, gold, silver, platinum, palladium, rhodium, and thallium.

Once the loaded resin is prepared, it is transferred to the elution column Optionally, the loaded resin is washed with a solution, which eluted unwanted classes of metal species, to remove any impurities before use. The wash solution may be dilute mineral acid or water. One or more eluents are added to the elution column to pass over and through the loaded resin. The eluent has a pH from about 0 to 14 an ORP (Oxidation Reduction Potential) or about 0 to 1000 millivolts, and a temperature of about −20 to 200° C. Exemplary eluents include mineral acids of various concentrations (e.g., HCl, H₂SO₄, HBr, HNO₃, H2SO₃), organic acids and amino acids of various strengths and combinations (e.g., acetic, lactic, glycolic, gluconic, glutamic, citric, oxalic), and brines of all concentrations and combinations (e.g., NaC1l, Na₂SO₄, NH₄Cl, MgSO₄). Preferably, the eluent comprises a brine, acid solution, or chelating agent solution. As the eluent passes over and through the loaded resin, the metals are liberated. Eluate bearing the metals exits the elution column is then passed through the enhancing column. The loaded resin still in the elution column may be regenerated in preparation to reload with more metals.

The enhancing column contains a fresh resin that may be an ion exchange resin, a chelating resin, or an absorbent resin. Optionally, the fresh resin is washed to remove any impurities before use. After the eluate passes over the fresh resin, it is recovered as discrete fractions such that the metals are substantially separated from one another. The fresh resin provides chromatographic retardation of the more tightly held resin, enabling substantial separation of the eluting metals. Each metal exits the enhancing column at a different rate through the fresh resin. In one embodiment, each target metal is collected in a separate product tank or other vessel. Substantially, means that at least 90% of the metal in the vessel is the target metal. Preferably, at least 95% of the metal in the vessel is the target metal.

The freshly eluted resin from the enhancing column may be regenerated for re-use. The eluate that exits that enhancing column is, preferably, collected for re-use.

FIG. 1 shows one embodiment of the system 1 of the invention. A plurality of vessels 5 receive a feed solution 11 and a resin 15 to be loaded with metals. The resin 15 may be supplied from a tank and may be fresh or regenerated. The feed solution 11 exits vessels 5 as barren ore slurry. The loaded resin 20 exits the vessels 5 and is transferred to the elution column 30. Eluent 21 is added to the elution column 30, where the eluent 21 passes over and through the loaded resin 20. Eluate 31, which contains metals liberated from the loaded resin 20, exits the elution column 30 and passes through a fresh resin in the enhancing column 32. The resin 17 from the elution column 30 may then be regenerated for re-use. Eluate 33 exits the enhancing column 32 and is collected as discrete fractions 35, 36, and 37 such that the target metals are substantially separated from one another. After the metals are separated fro the eluate 33, eluate 40 may then be collected for re-use.

The following examples are presented to illustrate the invention. In the examples, the following abbreviations have been used.
BV is Bed Volumes of solution where one Bed Volume equals the volume of resin in the column;
cm is centimeter;
Co is cobalt;
Cu is copper;
g is gram;
hr is hour;
IDA is iminodiacetic acid;
L is liters; and
ppm is parts per million.

### Test Method

Both the loaded resin samples and the liquid eluate samples were analyzed by portable XRF Model X-50 from Innov-X Systems (50 kV, 200 uA X-ray tube). Liquid samples were analyzed without dilution. Solid samples were pre-washed with de-ionized water and analyzed as whole uncrushed beads.

### EXAMPLES

### Comparative Example

Equilibrium loaded IDA resin (25 mL, AMBERLITE IRC-748i iminodiacetic acid chelating cation exchange resin, available from The DOW Chemical Company) containing 37.7 g/L of copper (II) and 5.0 g/L cobalt (II), both in their sulfate forms, was placed in a 1.1 cm ID glass ion exchange column and eluted stepwise: first, with 2% sulfuric acid solution, and finally, with 10% sulfuric acid solution, each at a rate of 3.8 BV/hr. The eluate was collected in ½ BV fractions and analyzed via portable XRF spectroscopy.

The resulting breakthrough curve shown in FIG. 2 illustrates that separation of the cobalt and the copper is very poor, yielding a cobalt containing fraction which is contaminated with copper so much that the cobalt to copper ratio is only 0.25:1 (25%, Separation Factor=18.0 compared to loaded resin Cu:Co ratio).

### Example 1

As in the Comparative Example, equilibrium loaded IDA resin (25 mL) containing 37.7 g/L of copper (II) and 5.0 g/L cobalt (II), both in their sulfate forms, was placed in a 1.1 cm ID glass ion exchange column In contrast to the Comparative Example, a fresh column of 25 mL of IDA resin AMBERLITE IRC-748i in the hydrogen form was placed in series with the loaded resin column in the lag position. Just as in the Comparative Example, the columns were eluted stepwise: first, with 2% sulfuric acid solution, and finally, with 10% sulfuric acid solution, each at a rate of 3.8 BV/hr. As in the Comparative Example, the eluate from the second (enhancing) column was collected in ½ BV fractions and analyzed via portable XRF spectroscopy.

The resulting breakthrough curve as shown in FIG. 3 illustrates the dramatic improvement the invention imparts on the cobalt/copper separation. Analysis of the breakthrough curve reveals that with the use of the enhancing column the cobalt containing fraction is substantially void of copper, with a cobalt to copper ratio of 53:1 (98%, Separation Factor=381.0 compared to loaded resin Cu:Co ratio).

### Example 2

As in Example 1, equilibrium loaded IDA resin (25 mL) containing 37.7 g/L of copper (II) and 5.0 g/L cobalt (II), both in their sulfate forms, was placed in a 1.1 cm ID glass ion exchange column. In contrast to the Comparative Example, a fresh column of 25 mL of IDA resin AMBERLITE IRC-748i in the hydrogen form was placed in series with the loaded resin column in the lag position. Just as in Example 1, the columns were eluted stepwise: first, with 2% sulfuric acid solution; then, with 15% sulfuric acid solution containing 44 g/L copper; and finally with fresh 15% sulfuric acid solution, each at a rate of 3.8 BV/hr. As in Example 1, the eluate from the second (enhancing) column was collected in ½ BV fractions and analyzed via portable XRF spectroscopy.

Just as in Example 1, the resulting breakthrough curve shown in FIG. 4 illustrates the dramatic improvement the invention imparts on the cobalt/copper separation even when the 2nd eluent is high tenor acidic copper solution vs. the fresh acid used in Example 1 and the Comparative Example. Analysis of the breakthrough curve reveals a cobalt/copper separation identical to that of Example 1 with a rapid return to baseline copper levels once the high tenor copper eluent is replaced with fresh 15% sulfuric acid.

What is claimed is:

1. A method for recovering metal ions from liquid or slurry solutions comprising:
providing an elution column and an enhancing column having a fresh resin;
contacting a solution with a resin that removes a plurality of metals from the solution to prepare a loaded resin;
transferring the loaded resin to the elution column;
adding an eluent to the elution column to pass over and through the loaded resin;
liberating the plurality of metals from the loaded resin;
passing eluate from the elution column with the plurality of metals through the enhancing column; and
recovering the eluate as discrete fractions such that the plurality of metals are substantially separated from one another.

2. The method of claim 1 wherein the contacting comprises:
loading the plurality of metals uniformly onto at least one of an ion exchange resin, a chelating resin, and an adsorbent resin.

3. The method of claim 1 further comprising:
washing any impurities from at least one of the loaded resin and the fresh resin before use.

4. The method of claim 1 further comprising:
collecting eluate from the enhancing column for re-use.

5. The method of claim 1 further comprising:
regenerating the loaded resin in preparation to reload with metals.

6. The method of claim 1 further comprising:
placing the elution column and the enhancing column in series.

7. The method of claim 1 further comprising:
eluting the loaded resin with at least two different solutions.

8. The method of claim 1 wherein the eluents comprise:
a pH from about 0 to 14;
an ORP of about 0 to 1000 mv; and
a temperature of about −20 to 200° C.

9. A system for recovering metal ions from liquid and slurry solutions comprising:
at least one vessel that receives a solution and a resin to be loaded with a plurality of metals;
an elution column that receives the loaded resin and an eluent;
an enhancing column having a fresh resin placed in series with the elution column that receives eluate with the plurality of metals liberated from the loaded resin; and
at least one collection vessel that collects the eluate as discrete fractions such that the plurality of metals are substantially separated from one another.

10. The system of claim 9 wherein the resin comprises at least one of an ion exchange resin, a chelating resin, and an adsorbent resin and the eluent comprises at least one of a brine, an acid solution, and a chelating agent solution.
